(19) United States
(12) Patent Application Publication
(10) Pub. No.: US 2019/0065824 A1
(43) Pub. Date: Feb. 28, 2019

(54) SPATIAL DATA ANALYSIS

(71) Applicant: Fugro N.V., Leidschendam (NL)

(72) Inventors: Chase GAUDET, Lafayette, LA (US); Marcus NEPVEAUX, Lafayette, LA (US); Kevin NORMAND, Lafayette, LA (US)

(73) Assignee: Fugro N.V., Leidschendam (NL)

(21) Appl. No.: 16/091,018

(22) PCT Filed: Apr. 4, 2017
(86) PCT No.: PCT/NL2017/050206

§ 371 Date: Oct. 3, 2018

(30) Foreign Application Priority Data
Apr. 4, 2016 (NL) 2016542

(51) Int. Cl. G06K 9/00; G06K 9/46; G06N 3/08; G06F 17/18

(52) U.S. Cl. CPC G06K 9/00214; G06F 17/18; G06N 3/08; G06K 9/4647

(57) ABSTRACT

The spatial data analysis system for processing spatial data comprises a statistical analysis module (20) and a convolutional neural network (30). The statistical analysis module (20) calculates a discrete two-dimensional spatial distribution (V(k,l)) of at least one statistical measure derived from said spatial data. The spatial distribution defines a statistical measure value of one or more statistical measure for respective raster elements (R(k,l)) in a two-dimensional raster for the data elements derived from the spatial data in the spatial window associated with the raster element. The convolutional neural network (30) is configured to provide object information of objects based on the statistical data.

### BACKGROUND OF THE INVENTION

### Field of the Invention

The present invention pertains to a spatial data analysis system.

The present invention further pertains to an arrangement comprising a 3D scanner for generating spatial data and such a system.

The present invention still further pertains to a spatial data analysis method.

### Related Art

Point cloud data is commonplace in the surveying and mapping industries, along with any field which requires computer modeling of natural or manmade objects. Point cloud data comprises a set of cloud points (pi(xi,yi,zi)) each being characterized at least by their coordinates in a three-dimensional coordinate system (x,y,z). Optionally, the points may be further characterized by other features, e.g. an intensity or an RGB value. Examples of fields using point clouds for modeling include healthcare, architecture, navigation, defense, insurance underwriting, regulatory, and many more. As remote sensing technology has improved over recent decades, the size and density of point cloud data has increased rapidly. It is not uncommon to encounter scenarios with billions of points in one small area of interest.

Maturana et al. discloses an application of convolutional neural networks for classifying objects using point cloud data in their article: “VoxNet: A 3D Convolutional Neural Network for Real-Time Object Recognition”, Intelligent Robots and Systems (IROS), 2015 IEEE/RSJ International Conference on. IEEE, 2015. The known system comprises a first component: a volumetric grid representing an estimate of spatial occupancy, and a second component in the form of a 3D convolutional neural network (CNN) that predicts a class label directly from the 3D occupancy grid.

It is further noted that Maturana, Daniel et al. discloses an application of 3D CNN in “3D Convolutional Neural Networks for landing zone detection from LiDAR”, 2015 IEEE International Conference on Robotics and Automation (ICRA), 26 mei 2015, bladzijden 3471-3478, XP055325310, DOI: 10.1109/ICRA.2015.7139679, ISBN: 978-1-4799-6923-4. This publication pertains to a system for detection of small and potentially obscured obstacles in vegetated terrain. Maturana et al. point out that the key novelty of this system is the coupling of a volumetric occupancy map with a 3D Convolutional Neural Network (CNN).

It is a disadvantage of these known systems that a relatively large amount of memory is required to store the 3D occupancy grid.

### SUMMARY OF THE INVENTION

It is an object to provide an improved spatial data analysis system and spatial data analysis method for obviating necessity of a 3D occupancy grid. It is a further object to provide an improved arrangement comprising a 3D scanner and the improved system.

The improved system comprises a statistical analysis module having an input to receive data elements having a data element position with coordinates in a two-dimensional coordinate system and a data element value for said data element position derived from the coordinates of respective spatial data points. The improved system is particularly suitable for processing point cloud data as the spatial data, e.g. rendered by a point cloud source (e.g. a Lidar arrangement) integrated in the system or may be retrieved from another source, e.g. from a memory or from a computer graphics system. The data elements to be processed by the statistical analysis module may be derived from the cloud points for example by selecting two of the coordinates (e.g. the x and y coordinates) of the cloud points as the two coordinates that determine the position of the cloud points while using the value of the third coordinate (e.g. the z-coordinate) as the value for the position. Alternatively the data points may be derived from spatially transformed cloud points, e.g. by first subjecting the cloud points to a rotation or a conversion from polar to Cartesian coordinates. A data element is said to originate from an object if the corresponding data point in the spatial data originates from that object. Where the spatial data is point cloud data this is the case if the cloud point corresponding to the data element originates from the object. The statistical analysis module calculates a discrete spatial distribution of at least one statistical measure derived from the data elements. The spatial distribution defines a statistical measure value of the at least one statistical measure for respective raster elements in a raster, preferably a two-dimensional raster. The statistical measure at least comprises an indicator indicative of an elevation distribution of data elements contained by the raster element. Therein each raster element is associated with a respective spatial window that comprises a subset of the data elements derived from the spatial data, e.g. the point cloud data. It is noted that in some cases the subset may be empty, for example near the edges of the observed range. Also this may be the case due to statistical fluctuations in the spatial distribution of the data points. Preferably the density of data points is in the order of 5 to 100 points per raster element, for example about 5 to 20 points per raster element. The statistical analysis module calculates the statistical measure value for a raster element from the respective values of the data elements comprised in the spatial window associated with the raster element. Therewith rasterized statistical data is obtained. The improved system further comprises a convolutional neural network that is communicatively coupled to the statistical analysis module to receive the rasterized statistical data and configured to provide a classification of objects based on the rasterized statistical data. Hence contrary to the known system the statistical analysis module is provided that converts the three-dimensional point cloud data to two-dimensionally rasterized statistical data and provides this as the input data to the convolutional neural network. It has been observed that the inclusion of the indicator indicative of an elevation distribution of data elements contained by the raster element as a statistical measure, enables a good performance of the system despite the reduction to two dimensions.

As indicated above, the improved system is particularly useful for analysis of point cloud data as the statistical analysis module provides rasterized statistical data as its output to the convolutional neural network independent of the spatial distribution of the spatial data. Nevertheless, the improved system is useful also for processing rasterized spatial data. Such rasterized spatial data could be considered as a special case of point cloud data, wherein the cloud points are arranged according to a raster instead of being arbitrarily scattered. The statistical analysis module can analogously use this spatial data as its input provided that the input raster with the spatial data has a sufficiently high resolution as compared to the spatial window used by the statistical analysis module, e.g. having a density of at least 5 spatial data points within the spatial window.

The improved arrangement comprises a 3D scanner for generating spatial data and an improved system as specified above to classify objects using said spatial data as specified by any of the previous claims and the improved system. In the context of this application a 3D scanner is understood to be a device that renders a three dimensional representation of a scanned range. The 3D scanner may be implemented in various ways, depending on the circumstances. For example the 3D scanner may have a fixed position or may be integrated with a movable carrier, e.g. a car, a plane or a vessel. Various technologies are available for this purpose, such as stereoscopic imaging, time of flight measuring. Imaging and/or measurement may be based on sensed signals of various nature, such as acoustic, optic or radar signals.

The improved spatial analysis method comprises:
receiving spatial data, which comprises a set of spatial data points each being characterized at least by their coordinates in a three-dimensional coordinate system,
calculating a discrete two-dimensional spatial distribution of at least one statistical measure from data elements having a data element position (p) in a two-dimensional coordinate system and a data element value (q) for said data element position (p) derived from the coordinates of spatial data points said spatial distribution defining a statistical measure value of said at least one statistical measure for respective raster elements in a raster, each raster element being associated with a respective spatial window comprising a subset of said set of points, the statistical measure value for a raster element being calculated from the respective data element values of the data elements in the subset of data elements comprised in the spatial window associated with the raster element, the discrete two-dimensional spatial distribution being rasterized statistical data,
providing the rasterized statistical data to a convolutional neural network, configured to provide object information about objects identified in the point cloud data by the spatial analysis method.

It has been found that good classification results can be obtained on the basis of rasterized statistical data. Therewith the need of a 3D occupancy grid is avoided.

Dependent on the application different types of object information may be provided. In an embodiment the object information is a classification of objects based on the statistical data. In another embodiment the object information is an estimated position of an object.

In an embodiment the two-dimensional spatial distribution is defined in a plane defined by a first and a second coordinate axis in said three-dimensional coordinate system, and wherein said quantity is an elevation defined in said three-dimensional system. As indicated above, an additional spatial transformation may be applied to spatially transform the spatial data, e.g. a point cloud into another coordinate system. It is also noted that further input data may be used, for example the intensity of a reflected beam resulting in the cloud point of the point cloud. Also such a quantity may be provided by another input means, for example a camera.

In an embodiment the statistical analysis module comprises a pre-filter for removing outliers from the data elements representing the spatial data, such as point cloud data. The pre-filter may for example remove data having a value for said quantity in the lower above the 95th or below the 5th percentile. A preprocessing module may further be used to combine point cloud data obtained from different recordings.

Useful statistical measures that may be calculated by the statistical analysis module are for example a point count density (N), a lowest elevation (LE), a highest elevation (HE), a difference between the highest elevation and the lowest elevation (HL), a maximum vertical gap (VG), a minimum vertical gap (LD), an average vertical gap (AD), an average elevation (AH), a standard deviation (SD), a surface normal vector (SN), a planar variance (PV), and a derived hard surface elevation (HS). The point count density indicates the number of data elements in each raster element. The lowest elevation is the lowest value observed for the elevation of the data elements in the raster element. The highest elevation is the highest value observed for the elevation of the data elements in the raster element. The maximum, the minimum and the average vertical gap respectively are the maximum difference, the minimum difference and the average difference in elevation between two consecutive data elements ordered in the z direction. The average elevation is the average value of the elevations of the data elements in the raster element. The standard deviation in this context is the standard deviation of the distribution of the elevation values. The surface normal vector is an indication of the normal vector of a surface interpolated through the data elements contained in the raster element. The planar variance is an indication of the extent to which the data elements deviate from the surface interpolated there through. The derived hard surface elevation is an indication of the surface hardness based on the intensity of the reflected beam used to generate the point cloud.

In an embodiment the statistical analysis module calculates as the statistical measure for the raster element at least an indicator indicative of an elevation distribution of data elements contained by the raster element. It has been found that this type of statistical measure renders it possible to achieve results that are comparable with results achievable with a 3D convolutional neural network, while still obviating the need of a 3D data representation. A possible explanation is that in the claimed system the CNN operates on 2D distributed data, contrary to the cited prior art which operates on an occupancy grid in three dimensions. The addition of a statistic measure indicative for an elevation distribution is believed to enable the CNN operating on the two dimensional raster to learn to recognize patterns of a three-dimensional nature.

Examples of indicators that are indicative of an elevation distribution of data elements are a difference between the highest elevation and the lowest elevation, a maximum vertical gap, a minimum vertical gap, an average vertical gap, a standard deviation, and a planar variance. A very suitable one of these indicators is the difference between the highest elevation and the lowest elevation as it can be computed with a minimum of computational effort.

The indicator indicative of an elevation distribution of data elements may be provided to the CNN for example in combination with a second indicator selected from a lowest elevation, a highest elevation, an average height, and a median height value.

Still further indicators may be provided, for example by adding time as input data to the statistical module. Using this information an indicator for e.g. a velocity or an acceleration value may be determined.

The convolutional neural network of the system may include one or more convolutional layers, one or more reduction layers and one or more fully connected layers. Reduction layers are for example pooling layers or dropout layers.

In an embodiment the convolutional neural network comprises ordered in the sequence from input to output a first pair of convolutional layers, a first pooling layer, a second pair of convolutional layers, a second pooling layer and a pair of fully connected layers.

An embodiment of the system further includes a post-processing module that is communicatively coupled to the convolutional neural network to receive the object information and to further process the object information. Therewith the post-processing module may extract further object information or to extract relation information about relations between identified objects.

### BRIEF DESCRIPTION OF THE DRAWINGS

These and other aspects are described in more detail with reference to the drawing. Therein:

FIG. 1 illustrates an embodiment of the system according to the invention,

FIG. 2 illustrates various elements relevant for operation of the system,

FIG. 3 illustrates exemplary architectures of a part of the system of FIG. 1,

FIG. 4 illustrates another embodiment of the system according to the invention,

FIG. 5 shows an example having overlaid therein the raw point cloud data and objects identified therein,

FIG. 5A shows a portion in more detail.

### DETAILED DESCRIPTION OF EMBODIMENTS

Like reference symbols in the various drawings indicate like elements unless otherwise indicated.

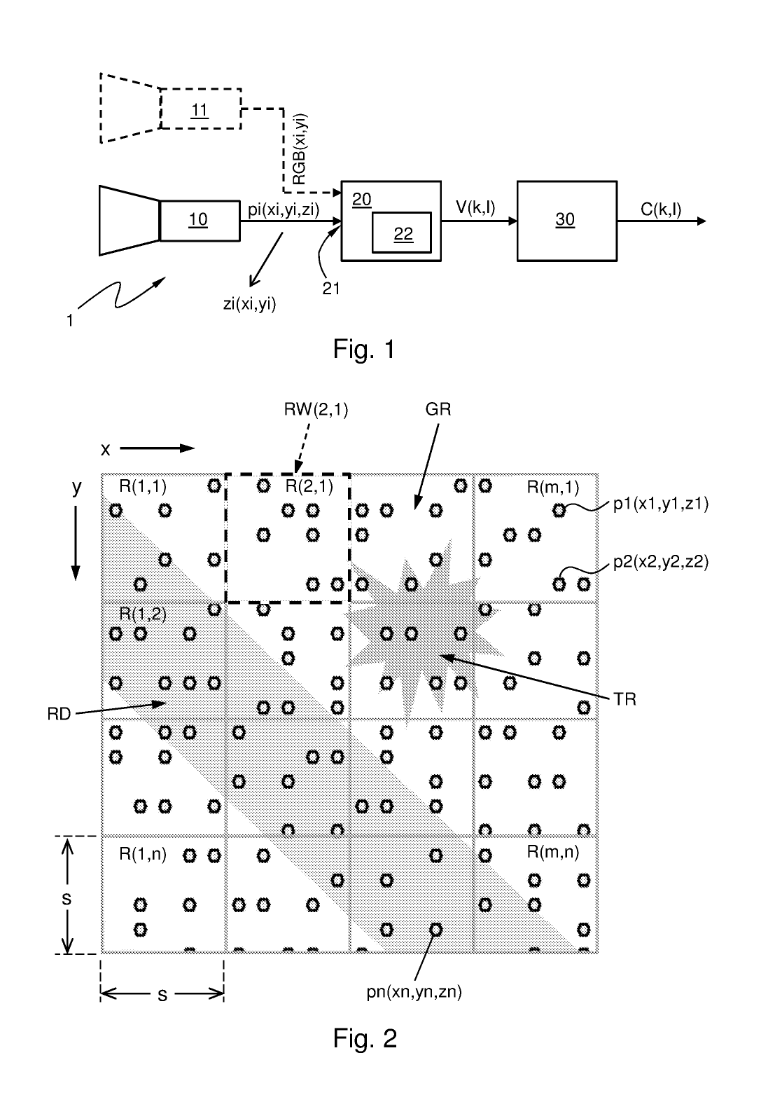

FIG. 1 schematically illustrates a spatial data analysis system 20, 30. The system, suitable for analysis of spatial data, such as point cloud data (pi(xi,yi,zi)) is part of an arrangement that further includes a 3D scanner for providing the spatial data. In the embodiment shown, spatial data is provided as point cloud data that comprises a set of cloud points (pi(xi,yi,zi)). Each data point, here a cloud point, is characterized at least by its coordinates in a three-dimensional coordinate system (x,y,z). In the embodiment shown, the cloud points are received as data elements zᵢ(xᵢ,yᵢ) having a data element position (p) with coordinates (xᵢ,yᵢ) in a two-dimensional coordinate system and a data element value (z) for said data element position (p) derived from the coordinates of respective cloud points. Hence in this embodiment the coordinates of a position (p) of a data element are determined by a first and a second one of the coordinates of the corresponding cloud point and its value (q) is determined by a third one of said coordinates.

In an alternative embodiment the system may further comprise a spatial transformation module to receive said point cloud data in the three dimensional coordinate system, and to transform the point cloud data to an alternative three dimensional coordinate system. In that case the coordinates of a position (p) of a data element may be determined by a first and a second one of the coordinates of the corresponding cloud point in the alternative three dimensional coordinate system and its value (q) may be determined by a third one of the coordinates in the alternative three dimensional coordinate system. Alternatively or in addition other quantities may be used. In the embodiment shown the system further receives input RGB(xi,yi) from a camera.

In another embodiment the spatial data may be provided as rasterized data points rp(xᵢ,yᵢ,zᵢ), wherein the coordinates xᵢ,yᵢ are positions on a raster and zᵢ are the values for the points on the raster. Similarly, this spatial data can be provided as data elements zi(xi,yi) having a data element position (p) with coordinates (x,yᵢ) in a two-dimensional coordinate system and a data element value (zᵢ) for said data element position (p) derived from the coordinates of respective cloud points.

FIG. 2 shows an example of cloud data obtained with a 3D scanner, here an imaging sensor having depth measurement capacity. Therein the image sensor generates spatial data as a point cloud comprising a set of n cloud points p1(x1,y1,z1), p2(x2,y2,z2), . . . , pn(xn,yn,zn). The cloud points pi(xi,yi,zi) are characterized by their coordinates (xi,yi,zi) in a three-dimensional coordinate system, and have a respective measured value for a quantity, here the depth zi of the cloud points. In this case the coordinate system is a Cartesian coordinate system defined by first and a second axis x,y as shown in the drawing and by a third axis z orthogonal to the drawing. Instead an alternative three dimensional coordinate system may be used, such as a polar coordinate system. By way of example the 3D scanner obtained an aerial survey from a scene comprising a road RD traversing a meadow GR on which further a tree TR is arranged. Numerous other applications are conceivable, such as visualization of a seabed surface.

As shown in FIG. 1, the system comprises a statistical analysis module 20 that has an input 21 to receive the spatial data, in this case the point cloud data, as data elements, each having an elevation zᵢ for a position with coordinates xᵢ,yᵢ. It further has a computation facility 22 to calculate a discrete two-dimensional spatial distribution (V(k,l)) of at least one statistical measure derived from the data elements derived from the point cloud data. The spatial distribution defines a statistical measure value of the at least one statistical measure for respective raster elements (R(k,l)) in a two-dimensional raster. Each raster element is associated with a respective spatial window (RW(2,1)) that comprises a subset of of the data elements. The statistical analysis module calculates the statistical measure value for a raster element from the respective values of the data elements contained in the spatial window associated with the raster element. It is noted that the contribution of the data elements in the calculation of the statistical value may be weighted by their position inside the spatial window. For example more centrally arranged data elements may be weighted higher than more peripherally arranged data elements. In the embodiment shown the spatial windows may form a tiling, i.e. the stride in the directions x,y is equal to the size of the spatial windows. Alternatively, the stride may differ from the dimension of the window. For example in case a weighting of the contribution of the data elements is applied the stride may be smaller than the window size, so that the tail of the weighting functions associated with mutually neighboring windows overlap.

By way of example the spatial window RW(2,1) of raster element R(2,1) is indicated by dashed lines. In the embodiment shown the raster elements have mutually non-overlapping spatial ranges, but, as indicated above, alternatively embodiments may be contemplated wherein spatial ranges of mutually neighboring ranges overlap to some extent. In the embodiment shown the spatial window of a raster element is a rectangle defined by an upper left coordinate xₖ,yₗ and a lower right coordinate xₖ₊₁, yₗ₊₁, wherein:

xₖ=k*sₓ; xₖ₊₁=(k+1)*sₓ, and

yₗ=l*s_{y}; yₗ₊₁=(l+1)*s_{y}

Therein sₓ,s_{y} are the sizes of the raster elements in the x- and the y-direction respectively. The size sₓ,s_{y} may be a function of the position x,y, for example to take into account the local density of the data elements. For example, in case of a non-homogeneous distribution of the data elements the size sₓ,s_{y} may be higher in areas having a low density of data elements than in areas having a high density of data elements, so that the number of data elements in each raster element is approximately equal.

In the embodiment shown, the sₓ,s_{y}=s, and each raster element contains about 5 to 10 data elements. However, in other embodiments the number of data elements may be lower or higher, depending on the required accuracy and on the available computational capacity.

The statistical analysis module 20 calculates a discrete two-dimensional spatial distribution of a statistical measure calculated for the data elements derived from the spatial data, here point cloud data. The spatial distribution defines a statistical measure value V(k,l) of the statistical measure for each of the raster elements from the data element values of the data elements contained in its associated spatial window. The statistical measure may be one of a plurality of statistical measures, and the statistical analysis module may calculate a discrete two-dimensional spatial distribution for each of the plurality of measures. Accordingly the result provided by the statistical analysis module is typically a two-dimensional raster of vectors. I.e. the statistical analysis module 20 calculates for each of the elements of the two-dimensional raster a vector having the values for the plurality of statistical measures as its components. It is alternatively possible to add one or more of the statistical measures as a dimension of the raster. For example the statistical analysis module 20 may provide its results in a three-dimensional coordinate system, having in addition to the coordinates k,l a third coordinate having a value equal to the value of one of the statistical measures, while providing the values of the remaining statistical measures as the values of the vector components for the elements defined by these three coordinates. Similarly the coordinate system may be extended with other statistical measures.

A preprocessing module may be provided that preprocesses the data elements derived from the raw spatial data (e.g. point cloud data), for example by removing outliers. For example the preprocessing module may remove data elements having a depth value above the 95th or below the 5th percentile. A further preprocessing module may be used to combine spatial data (e.g. point cloud data) obtained from different recordings.

Accordingly, in the embodiment shown, the statistical analysis module calculates the statistical measure value V(k,l) as:

V(k,l)=V(vqᵢ₁,vqᵢ₂, . . . , vqᵢₖₗ)

Therein

vqᵢ₁,vqᵢ₂, . . . , vqᵢₖₗ are the data element values of the data elements i1, i2, ikl, contained in the spatial window RW(k,l) of the raster element R(k,l). It is noted that the number of data elements contained in the spatial window RW(k,l) of a raster element R(k,l) may vary, and sometimes may be 0.

As indicated above, the statistical analysis module may apply a weighting function to weight the contribution of the values for the measured quantity. For example, the weighting function may apply a higher weight to values associated with data elements centrally arranged in the spatial window than to values of data elements that are more peripherally arranged.

The system further includes a neural network 30, here a convolutional neural network that receives the statistical data V(k,l) representing the discrete two-dimensional spatial distribution. In response thereto it provides information about objects based on the statistical data.

The statistical analysis module 20 may for example compute one or more of the following statistical measures for each raster element R(k,l) with spatial window RW(k,l), low elevation, high elevation, elevation standard deviation, surface normal vector, point count density and vertical gap. These statistical measures are defined as follows:

Point Count Density N

The point count density is the number N(k,l) of data elements contained in the spatial window.

$$N ( k , l ) = {\sum }_{i ∈ RW ( k , l )} 1$$

Low Elevation LE

The low elevation is defined as the minimum value for the elevation of the data elements contained in the spatial window.

$$LE ( k , l ) = {min}_{i ∈ RW ( k , l )} ( {z}_{i} ) ,$$

Therein i∈RW(k,l) denotes that i is a data element in the spatial window RW(k,l), and zᵢ is the elevation of that data element.

High Elevation HE

Similarly the high elevation measure is defined as follows:

$$HE ( k , l ) = {max}_{i ∈ RW ( k , l )} ( {z}_{i} )$$

High Minus Low HL

$$HL ( k , l ) = {max}_{i ∈ RW ( k , l )} ( {z}_{i} ) - {min}_{i ∈ RW ( k , l )} ( {z}_{i} )$$

Vertical Gap VG

A measure related to HL is the (maximum) vertical gap VG. This is the largest vertical separation between (valid) elevations in a raster element. Elevation is defined here as the value (zᵢ) of a data element. The wording valid is included between brackets to clarify that the measure is only based on the remaining elevations in case outliers are removed.

If for example a raster window contains data elements originating from a tree branch, and other data elements originating from the ground; the data elements originating from the tree branch will have similar elevations spread over a small range, and the data elements originating from the ground will have elevations spread over an even smaller range. The largest vertical separation is likely between the lowest point on the branch and the highest point on the ground. This separation is recorded as the vertical gap and can be computed as:

$$VG ( k , l ) = {max}_{i = 1 , … , N} ( {z}_{n ( i + 1 )} - {z}_{n ( i )} )$$

Therein n(i) is the function that indicates the i^{th} data element ordered by its z-value from small to large. I.e. n(1) indicates the data element with the smallest z-value and n(N) indicates the data element having the largest z-value.

Lowest Z Difference LD

Likewise a measure LD, which may also be denoted as “minimum vertical gap” may be defined as:

$$LD ( k , l ) = {min}_{i = 1 , … , N} ( {z}_{n ( i + 1 )} - {z}_{n ( i )} )$$

Average Z Difference AD

Further a measure AD, also denoted as “average vertical gap” may be calculated as:

$$AD ( k , l ) = \frac{1}{N} {\sum }_{1}^{N} ( {z}_{n ( i + 1 )} - {z}_{n ( i )} )$$

Average Elevation AH

The average elevation of the data elements contained in the spatial window RW (k,l) is defined as:

$$AH ( k , l ) = \frac{1}{N ( k , l )} {\sum }_{i ∈ RW ( k , l )} {z}_{i}$$

In an alternative embodiment the median value MD of the elevation may be calculated for the subset of data elements.

Standard Deviation SD

The standard deviation

$$SD ( k , l ) = \sqrt{\frac{1}{N ( k , l )} {\sum }_{i ∈ RW ( k , l )} {z}_{i}^{2} - ( \frac{{\sum }_{i ∈ RW ( k , l )} {z}_{i}}{N ( k , l )} )} = \sqrt{\frac{1}{N ( k , l )} {\sum }_{i ∈ RW ( k , l )} {z}_{i}^{2} - AH ( k , l )}$$

Surface Normal Vector SN

The surface normal vector may be estimated as a surface normal vector of a polynomial surface, that is interpolated through the data elements contained in the spatial window of the raster element R(k,l).

Accordingly as a first step a polynomial surface of degree p is fitted through the data elements contained in that spatial window.

$$z ( x , y ; k , l ) = {\sum }_{i + j \leq p} {α}_{i , j} {x}^{i} {j}^{j}$$

A least squares method may be applied for example. The degree p of the polynomial should not be too high in order to avoid overfitting. A maximum boundary of the degree p is defined by:

(p+1)(p+2)≤2N(k,l)

In an embodiment a plane is interpolated as the polynomial surface through the data elements contained in the spatial window.

After the interpolating surface is determined, its surface normal vector is determined at a characteristic position of the spatial window, typically the center of the spatial window.

The surface normal vector may be expressed in various ways, for example as a pair of the angle between the surface normal vector with the z-axis and the direction of the component of the surface normal vector transverse to the z-axis. In an embodiment the surface normal vector is expressed as the cosine of the angle with the z-axis.

Planar Variance PV

The planar variance is a measure that indicates to which extent the data elements contained in the raster element fit into a plane interpolated through the data elements. When using a least square method to determine the best fitting plane for a raster element R(k,l), the minimal value of the squared error is the planar variance PV(k,l). Related statistics may be defined using another distance measure, e.g. when applying an interpolation method that minimizes the absolute value of the error, the minimized absolute value is the planar variance.

Derived (Hard) Surface Elevation HS

Derived surface elevation is an estimated elevation of the ground without consideration for man-made objects (example: vehicles, towers, signs, buildings, or bridges). Derived hard surface elevation is an estimated elevation of any building, bridge, or ground in the cell; without consideration for other man-made objects).

Information from other data sources may be combined with the rasterized statistical information. The information from these other sources may already be present in a rasterized format, for example as RGB (x,y) data or rasterized intensity data obtained with a camera, for example a camera operating in the visual spectrum or in the infrared spectrum. Additional channels can be included to provide this rasterized data in a manner compatible with the rasterized statistical data. I.e. for each raster element input data for a measured RGB or intensity value may be provided in addition to one or more of the statistical data. Compatibility may be achieved by a geometrical transformation and/or spatial interpolation of the additional data.

Data-elements may be associated with a time of acquisition of the spatial data from which they are derived. Presumed that a sufficient number of data elements is available, the associated acquisition time may be used to estimate a temporal behavior of an object represented by the data cloud. The temporal behavior, e.g. a velocity of the object can be estimated by interpolating a 4-dimensional hyperplane through data elements derived from the observed data points

For a hyperplane defined by:

aₓx+a_{y}y+a_{z}z−aₜt=q

the velocity vₖ in a direction k (x,y,z) of the object can be estimated as

$${v}_{k} = \frac{{a}_{t}}{{a}_{z}}$$

Also higher order temporal behavior may be estimated, for example by comparing the estimated velocities at mutually subsequent points in time.

As further shown in FIG. 1, the system comprises a convolutional neural network 30, that is communicatively coupled to the statistical analysis module 20 to receive the rasterized statistical data V(k,l) prepared by the statistical analysis module 20. The convolutional neural network is configured to provide a information about objects identified by the system, for example a classification (C(k,l)) of objects, or an estimated position of an object (present in the range observed by an 3D scanner) based on the rasterized statistical data.

The convolutional neural network 30 comprises a plurality of layers, wherein the first layer receives the rasterized statistical data V(k,l), and wherein each subsequent layer processes output data obtained from the previous layer. The final layer provides the classification result C(k,l).

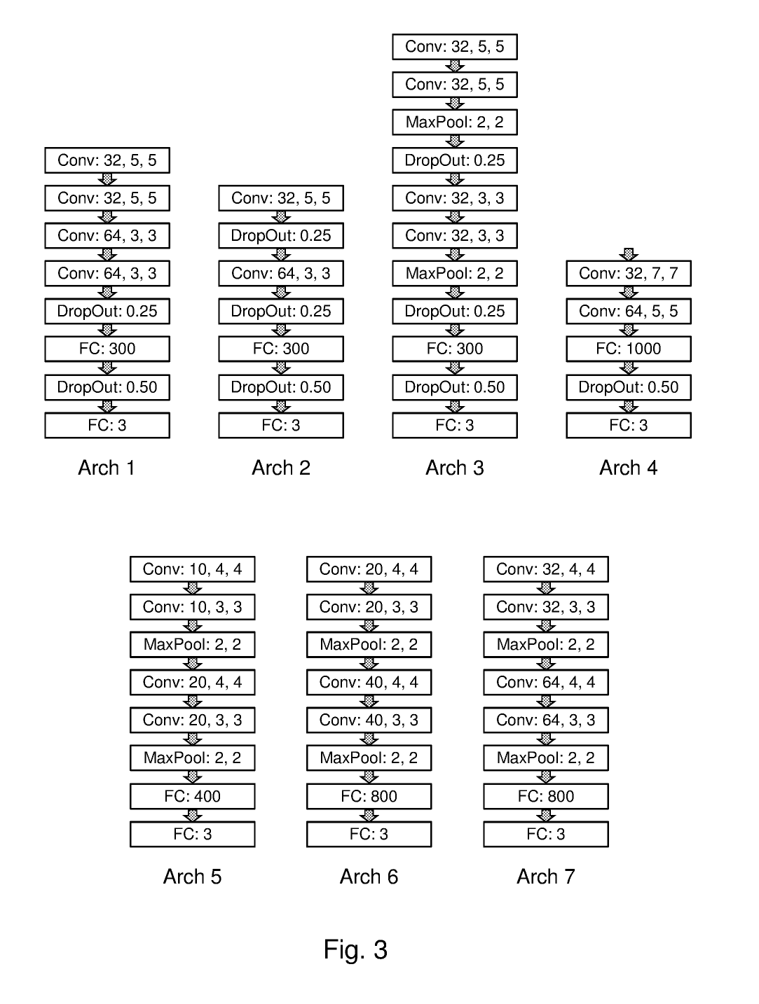

Exemplary implementations (Arch1, . . . Arch7) of the convolutional neural network are shown in FIG. 3. The convolutional neural network typically contains one or more convolutional layers, one or more reduction layers and one or more fully connected layers. In the path through the various layers, starting with the inputs of the first layer that retrieves the data elements from the statistical analysis module 20 to the output of the last layer, object information is retrieved about objects identified in the spatial data. Depending on the application, the retrieved information may for example indicate a class to which an object is assigned or an object position. The retrieved information may alternatively be provided as a probability distribution across classes or positions. Also embodiments are conceivable where the CNN 30 provides at its output information about various aspects of an object or objects.

Convolutional Layers

The convolutional layers, denoted as Conv k,n,m create feature maps by convolving the input with k learned filters (kernels) of a particular shape and of size n,m pixels. The parameters of this type of layer are the number of kernels k, and their spatial dimensions n,m. For example a convolutional layer denoted as Conv 32, 5, 5 uses 32 kernels having a window sized 5×5 pixels. When the input is an N×M image, the result is an (N−n+1)×(M−m+1) vector image. Therein each pixel is a vector of length k, wherein each element of the vector is a value for a particular feature associated with the respective kernel at the position of the pixel. Convolution can also be applied at a spatial stride. The output may be passed through a nonlinearity unit.

It is noted that the wording ‘image’ and ‘pixel’ are used here in a broad sense. The wording pixel in this context is an element associated with a position in a raster and having a vector of one or more features. The wording image in this context is the set of pixels in this raster.

Reduction Layers

A reduction layer provide for a data reduction in particular to avoid overfitting. One type of reduction layer is a pooling layer (MaxPool: n,m). A layer of this type provides for a data reduction by downsampling. In particular this type of layer downsamples the data retrieved from its input raster by selecting the maximum value of the inputs on a window of n×m data elements. Typically the windows used for the MaxPool layer provide for a tiling of the input image, so that the windows are displaced with stride n in the first direction and with stride m in the second direction. This implies that the number of pixels is reduced by a factor n in the first direction and a factor m in the second direction.

Accordingly, a reduction layer of type MaxPool: with m=2 and n=2 will partition the input raster into 2×2 windows and provide for a data reduction of 4:1. However, alternative embodiments may be considered wherein the stride differs from the dimensions of the window. Also other subsampling techniques may be used, such as Fractional MaxPooling.

Another type of reduction layer is a dropout layer (DropOut: p)). The dropout layer is configured during training by removing nodes of the layer with probability p in each training stage. Only the reduced network is trained on the data in that stage. The removed nodes are then reinserted into the network with their original weights. Upon completion of the training each of the weights is assigned a value equal to the average of the values determined for that weight during the stages of the training. The average of the values is normalized by division with 1−p.

Fully Connected Layers

In a fully connected layer (FC: nn), the output of each neuron is a learned linear combination of all the outputs from the previous layer, passed through a nonlinearity. In case the previous layer provides its outputs as a vector having a plurality of vector elements for each neuron, the output of each neuron in the fully connected layer is based on the weighted combination of the values of each of the vector elements of each of the outputs of the previous layer. Nevertheless in the trained CNN 30, individual weights may have a value of zero. The fully connected layer may provide its output a classification, i.e. an indicator indicative for a selection from a predetermined set of classes. The parameter nn indicates the number of neurons in the layer.

Activation Function

The nodes of a layer use an activation function to determine whether a weighted set of inputs matches a particular pattern. The activation function typically provides for a non-linear mapping of a sum of the weighted set of inputs to a value in the range of [0,1], for example using the sigmoid function. Also other activation functions may be used, for example, the non-saturating function f(x)=max(0,x) or the hyperbolic tangent function.

In the exemplary architecture Arch1 in FIG. 3, the CNN subsequently four convolutional layers Conv: n, m, n, a reduction layer, a fully connected layer, a reduction layer and a fully connected layer. Both reductions layers are provided as a dropout layer indicated as DropOut p. The fully connected layers, indicated as FC: nn, assign one of nn classes to their outputs.

The second exemplary architecture Arch2 differs from the first example Arch1, in that the first four convolutional layers are replaced by a first convolutional layer, a reduction layer and a second convolutional layer.

The third exemplary architecture Arch3 differs from the first example Arch1, in that subsequently a pooling layer (MaxPool: 2,2) and a dropout layer (DropOut: 0.25) are inserted. Additionally a further pooling layer (MaxPool: 2,2) is inserted between the fourth convolutional layer and the subsequent layers.

The fourth example Arch4 can be considered as a simplification of the example Arch2, in that the two dropout layers are left out.

Architectures Arch5, Arch6 and Arch7 have the same arrangement, sequentially comprising the a first pair of convolutional layers, a first pooling layer, a second pair of convolutional layers, a second pooling layer and a pair of fully connected layers. These architectures however differ in that these layers are provided with mutually different parameters.

General direction concerning training the CNN as provided for example in the following documents.

Must Know Tips/Tricks in Deep Neural Networks by Xiu-Shen Wei, retrieved from http://lamda.nju.edu.cn/weixs/project/CNNTricks/CNNTricks.html on 25 Mar. 2016.

Therein Xiu-Shen Wei amongst others considers various strategies for efficiently training convolutional neural networks, such as data augmentation, pre-processing on images, initializations of networks, selections of activation functions, diverse regularizations, methods of ensemble multiple deep networks.

As noted by Xiu-Shen Shan, an important issue is to keep the learning rate at a modest level. If it is found that to much ‘neurons’ not become active for the entire training set, the learning rate should be decreased. Optionally upon completion of the training, the most upper layers of the CNN, i.e. near its input, may be fine tuned while keeping fixed the settings for the deepest layers, i.e. near the output. Further information on training of CNN can be found in “Recent Advances in Convolutional Neural Networks”, by Jiuxiang Gu et al, retrieved from http://arxiv.org/pdf/1512.07108.pdf on 25 Mar. 2016.

Additional information concerning possible implementations of the various layers and their activation functions can be found for example in the Wikipedia article on this subject (https://en.wikipedia.org/wiki/Convolutional_neural_network).

Experimental Results

Point cloud data was obtained by scanning a terrain with buildings and ditches using point cloud data distributed in a three-dimensional space, defined by a Cartesian coordinate system, having x,y coordinates defining the plane of the observed area and a z-coordinate defining an elevation (also denoted as height). The point cloud data was obtained with a LIDAR sensor measuring in a substantially downward oriented direction. According to standard practice, using gps and inertial navigation information and taking into account the relative sensor position and orientation the sensed data was transformed to a common x, y, z coordinate system. The transformed point cloud data elements so obtained were then converted into rasterized statistics.

The rasterized statistics were calculated for a raster having raster elements sized 1 m×1 m based on an average number of about 10 data elements per raster element. The following rasterized statistics, as defined above, were calculated. {LE(k,l); HE(k,l); HL(k,l); SD(k,l); SN(k,l)}.

One or more of these rasterized statistics were provided to a neural network to classify elements in the terrain or the absence thereof. I.e. the neural network was setup to output for each pixel, representing a 1 m×1 m portion of the terrain, a classification selected from the classes “building”, “ditch”, or neither of these two. For training and validation of the system a manual classification was prepared wherein any manmade structure of significant size and shape to be considered “building” was labeled as such. The structures labeled as buildings typically have a height of at least 2 m, an dimensions having an order of magnitude of 5 m or more in planar directions, e.g. a size of at least 4 m in one planar direction, and a size of at least 6 m in another direction. Rooftops can be flat or slanted (“gable” and “hip” roofs). The structures labeled as ditches are typically linear features, typically having a depth in the range of a few tenths of meters to a few meter, e.g. 0.3 m-2 m, a width in the range of about one meter to a few meters, e.g. 1-3 m and a length in the range of a few meter and longer.

Various embodiments of the convolutional neural network, using one or more of the above-mentioned rasterized statistics, were investigated. In the first experiment the performance of the seven architectures of FIG. 3 was compared using all five rasterized statistics. All used Rectified Linear Units (ReLU) as their activation function. The results of this experiment are presented in Table 1.

TABLE 1
Accuracy (TestAcc (%)) and Categorical Cross Entropy (CCEloss) value
for each of the architectures Arch 1 to Arch 7.

| ARCH | CCEloss | TestAcc (%) |
|---|---|---|
| Arch1 | 0.8935 | 70.3 |
| Arch2 | 0.8891 | 73.7 |
| Arch3 | 0.3735 | 85.1 |
| Arch4 | 0.2164 | 86.5 |
| Arch5 | 0.1799 | 88.3 |
| Arch6 | 0.1077 | 89.1 |
| Arch7 | 0.0994 | 90 |

In a second experiment it was investigated in which way the performance was influenced by the choice of the rasterized statistical data, provided as input to the convolutional neural network for the architectures Arch5, Arch6 and Arch7. The results are presented in tables 2-4 below.

TABLE 2
Accuracy (TestAcc (%)) and Categorical Cross Entropy (CCEloss) value
for architecture Arch5 using various rasterized statistical data.

| Channels | LE | HE | HL | SD | SN | CCEloss | TestAcc (%) |
|---|---|---|---|---|---|---|---|
| 1 | LE | | | | | 0.1773 | 89.9 |
| 2 | LE | HE | | | | 0.1694 | 89.5 |
| 3 | LE | HE | HL | | | 0.1529 | 90.2 |
| 4 | LE | HE | | SD | | 0.1638 | 92.5 |
| 5 | LE | HE | | | SN | 0.4562 | 84.0 |
| 6 | LE | HE | HL | SD | | 0.5233 | 86.8 |
| 7 | LE | HE | | SD | SN | 0.6465 | 80.7 |
| 8 | LE | HE | HL | SD | SN | 0.1607 | 88.3 |

TABLE 3
Accuracy (TestAcc (%)) and Categorical Cross Entropy (CCEloss) value
for architecture Arch6 using various rasterized statistical data.

| Channels | LE | HE | HL | SD | SN | CCEloss | TestAcc(%) |
|---|---|---|---|---|---|---|---|
| 1 | LE | | | | | 0.1093 | 87.3 |
| 2 | LE | HE | | | | 0.1052 | 90.1 |
| 3 | LE | HE | HL | | | 0.1043 | 93.0 |
| 4 | LE | HE | | SD | | 0.1082 | 90.2 |
| 5 | LE | HE | | | SN | 0.1158 | 70.7 |
| 6 | LE | HE | HL | SD | | 0.0995 | 88.2 |
| 7 | LE | HE | | SD | SN | 0.1221 | 85.0 |
| 8 | LE | HE | HL | SD | SN | 0.1077 | 89.1 |

TABLE 4
Accuracy (TestAcc (%)) and Categorical Cross Entropy (CCEloss) value
for architecture Arch7 using various rasterized statistical data.

| Channels | LE | HE | HL | SD | SN | CCEloss | TestAcc(%) |
|---|---|---|---|---|---|---|---|
| 1 | LE | | | | | 0.0992 | 91.1 |
| 2 | LE | HE | | | | 0.0995 | 91.9 |
| 3 | LE | HE | HL | | | 0.0951 | 89.1 |
| 4 | LE | HE | | SD | | 0.0961 | 93.4 |
| 5 | LE | HE | | | SN | 0.1018 | 77.4 |
| 6 | LE | HE | HL | SD | | 0.0851 | 92.1 |
| 7 | LE | HE | | SD | SN | 0.1099 | 83.9 |
| 8 | LE | HE | HL | SD | SN | 0.0994 | 90.0 |

The results from the architecture trials show that the more complex networks are not necessarily better. For example Arch 4, being the smallest network also performed reasonably well. It was further observed that in the current application inclusion of DropOut layers did not contribute to an improved performance. This may be due to the fact that it is very hard to overfit on this type of data, since the entities to be classified are relatively smooth. In other applications, for example classification of animals invariant of their age and of the angle of observation, the risk of overfitting is higher and one or more additional DropOut layers may improve performance to avoid this.

It was further noted that adding more channels does not guarantee better results. In these experiments it was observed that adding channel 4, Surface Normal (SN), negatively affects classification accuracy. It is presumed that this also is related to the type of objects considered in this experiment. The objects: buildings, ditches and background typically do not have extreme changes in this particular measure of surface normals as it is calculated per pixel, not using neighboring data. In other applications inclusion of the feature surface normal may positively affect accuracy.

Another interesting result is that the performance of the system, even of a deep CNN, is usually improved by adding in the High Minus Low statistic (HL) or another statistic that is indicative for a variation of the elevation (a height distribution), e.g. the variation, standard deviation, or a lowest z difference (LD), a highest z difference (vertical gap VG) or an average z-difference (AD). Also planar variance PV could be used as an indicator in this respect. A possible explanation is that in the claimed system the CNN operates on 2D distributed data, contrary to the cited prior art which operates on an occupancy grid in three dimensions. It is submitted that the addition of a statistic measure indicative for an elevation distribution enables the CNN 30 operating on the two dimensional raster to learn to recognize patterns of a three-dimensional nature.

The statistic HL has the relative advantage that its calculation is of a low computational complexity.

In the embodiment presented above, the spatial data analysis system provides as the object information a classification C(k,l) of objects based on the statistical data.

In an alternative embodiment the spatial data analysis system provides an estimated position of an object as the object information.

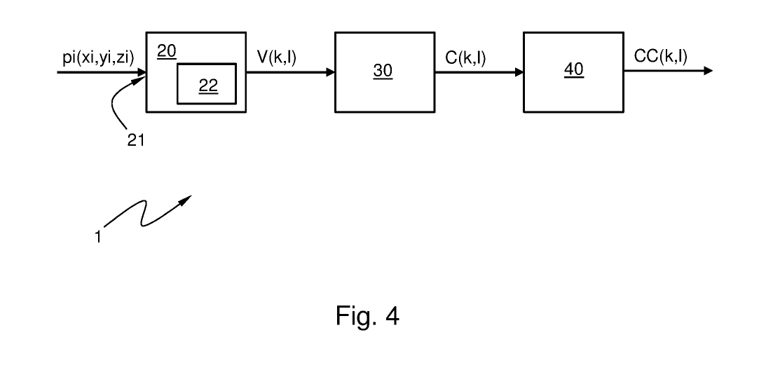

Still further, as illustrated in FIG. 4, the system may comprise an additional post processing module 40 that applies a post-processing step on the object information rendered by the CNN 30. The post-processing module 40 may for example use prior knowledge about the morphology of structures to be identified and determine if such structures appear in the image. In an embodiment the post-processing module 40 may be a dedicated processor having hardwired image processing functionalities, a suitably programmed general data processor or a suitably programmed dedicated image processor. Alternatively, it may be considered to provide the post-processing module 40 as another CNN, or even as a further set of layers of the CNN 30.

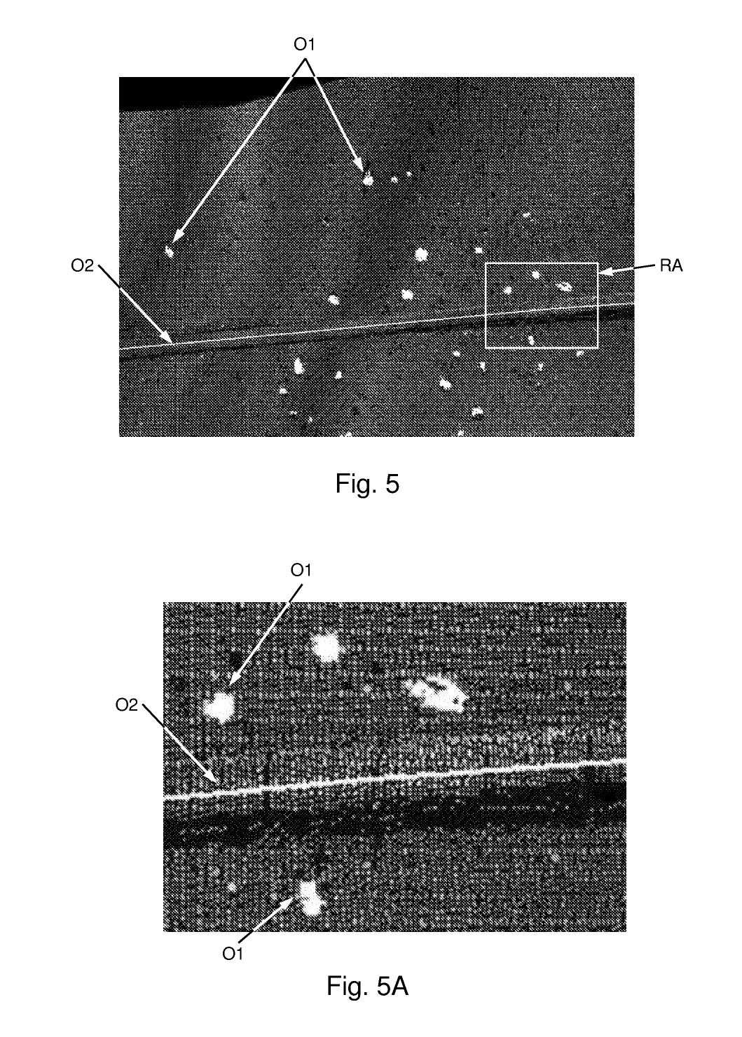

By way of example FIG. 5 shows an image obtained from point cloud data obtained as a result of a survey of a seabed with a multi beam echo sounder. The point cloud data has a density varying from about 10 to about 100 points per square meter. Good results were obtained with a statistical data raster having raster element in the range between 0.25×0.25 m to 1×1 m. A magnified subarea shown in FIG. 5A corresponding to the rectangle RA in FIG. 5 shows data elements corresponding to individual points in the point cloud. The system of e.g. FIG. 1 or FIG. 4 can be trained by providing labeled training data together with the statistical data provided by the statistical analysis module 20 to the CNN 30. Exemplary training data is illustrated in FIGS. 5, 5A as spots O1 indicating boulders & seafloor contacts and line O2 indicating the center of a pipeline. With a sufficient amount of this training data the spatial data analysis system can be trained to recognize such objects and their location. In the present example, the pipeline indicated by line O2 has a diameter of 1.5 m and the elements indicated by spots O1 have dimensions in the order of 0.2 m and more.

It is noted that the computational resources of the system may be integrated. Alternatively, these resources may be geographically spread and communicatively coupled. Computational resources may be provided as dedicated hardware, as generally programmable devices having a dedicated control simulation program, as dedicated programmable hardware having a dedicated program, or combinations thereof. Also configurable devices may be used, such as FPGA's.

Although in the examples presented above, the point cloud data was sensed in a generally downward direction, the measures as claimed herein are equally applicable to applications wherein the point cloud data is sensed in another direction. It is merely relevant that a cloud of three-dimensionally distributed point data is obtained which is converted to two-dimensionally rasterized statistical data, that comprises at least an indicator indicative of an elevation distribution of data elements contained by the raster elements. Further according to the presently claimed measures, this two-dimensionally rasterized statistical data is provided to a two-dimensional convolutional neural network configured to provide object information about objects identified in the point cloud data.

Likewise, the spatial data source, e.g. point data source, does not need to integrated in the system. The system may for example use existing spatial data, for example obtained with photography, video footage. Spatial data could also have been obtained using image rendering methods.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

While the present invention has been described with respect to a limited number of embodiments, those skilled in the art will appreciate numerous modifications and variations therefrom within the scope of this present invention as determined by the appended claims.

1. A spatial data analysis system for analysis of spatial data comprising a set of spatial data points each being characterized at least by their coordinates in a three-dimensional coordinate system, the system comprising a convolutional neural network, to receive input data and being configured to provide object information about objects identified in the spatial data by the spatial data analysis system, characterized in that the spatial data analysis system further comprises a statistical analysis module having an input to receive data elements having a data element position with coordinates in a two-dimensional coordinate system and a data element value for said data element position derived from the coordinates of respective spatial data points, and having a computation facility to calculate a discrete spatial distribution of at least one statistical measure, said spatial distribution defining a statistical measure value of said at least one statistical measure for respective raster elements in a two-dimensional raster, each raster element being associated with a respective spatial window comprising a respective subset of said data elements, said statistical analysis module calculating the statistical measure value for a raster element from the respective data element values of the data elements in the subset of data elements comprised in the spatial window associated with the raster element, wherein said statistical analysis module calculates as the statistical measure for the raster element at least an indicator indicative of an elevation distribution of data elements contained by the raster element, and wherein said convolutional neural network is communicatively coupled to the statistical analysis module to receive said statistical data as input data.

2. The system according to claim 1, wherein the indicator is indicative of an elevation distribution is selected from one of a difference between the highest elevation and the lowest elevation, a maximum vertical gap, a minimum vertical gap, an average vertical gap, a standard deviation, and a planar variance.

3. The system according to claim 1, wherein the statistical analysis module further calculates as the statistical measure for the raster element at least one of a lowest elevation, a highest elevation, an average elevation, and a median elevation value.

4. The system according to claim 1, wherein said statistical analysis module further calculates as the statistical measure for the raster element at least one of a point count density, a surface normal vector, and a derived hard surface elevation.

5. The system according to claim 1, wherein the object information is a classification of objects based on the statistical data.

6. The system according to claim 1, wherein the object information is an estimated position of an object.

7. The system according to claim 1, wherein the coordinates of a position of a data element are determined by a first and a second one of the coordinates of the corresponding data point and wherein its value is determined by a third one of said coordinates.

8. The system according to claim 1, further comprising a spatial transformation module to receive said spatial data in said three dimensional coordinate system, and to transform said spatial data to an alternative three dimensional coordinate system, and wherein the coordinates of a position of a data element are determined by a first and a second one of the coordinates of the corresponding spatial data in said alternative three dimensional coordinate system and wherein its value is determined by a third one of said coordinates in said alternative three dimensional coordinate system.

9. The system according to claim 1, wherein said statistical analysis module comprises a pre-filter for removing outliers from the data elements representing the spatial data.

10. The system according to claim 1, further comprising a spatial sensor for determining a spatial distribution of a quantity associated with an observed surface.

11. The system according to claim 10, wherein said spatial sensor is a camera and the quantity associated with the observed surface is an RGB value.

12. The system according to claim 1, wherein the convolutional neural network includes one or more convolutional layers, one or more reduction layers and one or more fully connected layers.

13. The system according to claim 12, wherein the convolutional neural network comprises ordered in the sequence from input to output a first pair of convolutional layers, a first pooling layer, a second pair of convolutional layers, a second pooling layer and a pair of fully connected layers.

14. The system according to claim 1, further including a post-processing module, communicatively coupled to said convolutional neural network to receive the object information and to further process the object information to extract further object information or to extract relation information about relations between identified objects.

15. An arrangement comprising
3D scanner for generating spatial data and the spatial data analysis system of claim 1 to classify objects.

16. The arrangement according to claim 15, wherein said 3D scanner is a Lidar.

17. The arrangement according to claim 15, wherein said 3D scanner is a Multibeam Echosounder.

18. A spatial data analysis method for analysis of spatial data comprising a set of data points each being characterized at least by their coordinates in a three-dimensional coordinate system, the method comprising:
receiving said spatial data,
providing input data to a convolutional neural network, configured to provide object information about objects identified in the spatial data by the spatial data analysis method,
characterized by calculating a discrete spatial distribution of at least one statistical measure from data elements having a data element position in a two-dimensional coordinate system and a data element value for said data element position derived from the coordinates of respective data points, said spatial distribution defining a statistical measure value of said at least one statistical measure for respective raster elements in a two-dimensional raster, each raster element being associated with a respective spatial window comprising a subset of said set of data elements, the statistical measure value for a raster element being calculated from the respective data element values of the data elements in the subset of data elements comprised in the spatial window associated with the raster element, the discrete spatial distribution being rasterized statistical data, wherein the statistical measure for the raster element at least comprises an indicator indicative of an elevation distribution of data elements contained by the raster element, and wherein the rasterized statistical data is provided as the input data to the convolutional neural network.
